(19) United States
(12) Patent Application Publication
(10) Pub. No.: US 2023/0302507 A1
(43) Pub. Date: Sep. 28, 2023

(54) MANAGEMENT SYSTEM, MANAGEMENT DEVICE, MANAGEMENT METHOD, AND PROGRAM

(71) Applicant: ORGANO CORPORATION, Tokyo (JP)

(72) Inventors: Masami IMAMURA, Tokyo (JP); Daisaku YANO, Tokyo (JP); Ryo IIZUKA, Tokyo (JP); Toshiaki NIHEI, Tokyo (JP); Yui WATANABE, Tokyo (JP)

(73) Assignee: ORGANO CORPORATION, Tokyo (JP)

(21) Appl. No.: 18/122,778

(22) Filed: Mar. 17, 2023

(30) Foreign Application Priority Data
Mar. 22, 2022 (JP) 2022-045791

(51) Int. Cl. B08B 9/46; G06F 16/24; B08B 3/04

(52) U.S. Cl. CPC B08B 9/46; G06F 16/24; B08B 3/04; B08B 2209/08

(57) ABSTRACT

A management system includes: a database that stores a first cleanliness indicating the liquid quality of the cleaning solution after the cleaning unit that cleans a container to which unique identification information is assigned cleans the container, in association with the identification information assigned to the container, and a management device that searches the database for the identification information associated with the first cleanliness that corresponds with a second cleanliness requested from the outside, and outputs the identification information that was retrieved.

### RELATED APPLICATION INFORMATION

This application claims priority to Japanese Patent Application No. 2022-045791, filed Mar. 22, 2022, which is incorporated herein by reference in its entirety.

### BACKGROUND OF THE INVENTION

### Technical Field

This invention relates to a management system, a management device, a management method, and a program.

### Description of the Related Art

In recent years, the reuse of resources has been taking place in various fields. For example, a technology has been considered in which used adsorbent cartridges are collected, the recyclability of the adsorbent is determined based on the amount of residual moisture of the adsorbent separated from the collected adsorbent cartridges, and the adsorbent that is determined to be recyclable is packed into containers for reassembly of adsorbent cartridges (see, for example, JP 2010-125396).

### SUMMARY

In technologies such as the one described in patent document JP 2010-125396, there is only one criterion for determining if a resource is recyclable, and the recycled resource does not necessarily meet the needs of users. As a result, there is a risk that resources may not be provided according to the needs of users.

The purpose of the present invention is to provide a management system, management device, management method, and program that can provide resources that meet the needs of users.

The management system of the present invention comprises:
a database that stores a first cleanliness indicating liquid quality of cleaning solution after a first cleaning unit that cleans containers to which unique identification information is assigned has cleaned the container in association with the identification information assigned to the container;
a search unit that searches the database for identification information associated with the first cleanliness that corresponds with a second cleanliness requested from the outside; and
an output unit that outputs the identification information that was retrieved by the search unit.

In addition, the management device of the present invention comprises:
an identification information acquisition unit that acquires identification information uniquely assigned to a container;
a decision unit that determines a cleaning method for the container from which filler has been removed based on the state of contamination of cleaning solution after the container was cleaned with the filler in it;
a cleanliness acquisition unit that acquires a first cleanliness indicating liquid quality of cleaning solution after cleaning the container from which the filler has been removed using the cleaning method determined by the decision unit, and stores in a database the acquired first cleanliness in association with the identification information that was assigned to the container and that was acquired by the identification information acquisition unit;
a search unit that searches the database for identification information associated with the first cleanliness that corresponds with a second cleanliness requested from the outside; and
an output unit that outputs the identification information retrieved by the search unit.

In addition, the management method of the present invention comprises:
a process of acquiring identification information uniquely assigned to a container;
a process of cleaning the container;
a process of acquiring liquid quality of cleaning solution after cleaning the container;
a process of storing in a database a first cleanliness indicating the acquired liquid quality in association with the acquired identification information assigned to the container;
a process of searching the database for identification information associated with the first cleanliness that corresponds with a second cleanliness requested from the outside; and
a process of outputting the identification information that was retrieved.

In addition, the program is a program for causing a computer to execute:
a procedure for acquiring identification information uniquely assigned to a container;
a procedure for cleaning the container;
a procedure for acquiring liquid quality of cleaning solution after cleaning the container;
a procedure of storing in a database a first cleanliness indicating the acquired liquid quality in association with the acquired identification information assigned to the container;
a procedure for searching the database for identification information associated with the first cleanliness that corresponds with a second cleanliness requested from the outside; and
a procedure for outputting the identification information that was retrieved.

In this invention, resources can be provided that meet the needs of users.

### BRIEF DESCRIPTION OF DRAWINGS

FIG. 1 is a diagram showing the first embodiment of the management system of the present invention.

FIG. 2 is a diagram showing an example of a container managed by the management system shown in FIG. 1.

FIG. 3 is a diagram showing an example of the association between identification information and cleanliness stored in the database shown in FIG. 1.

FIG. 4 is a diagram showing an example of the internal configuration of the management device shown in FIG. 1.

FIG. 5 is a flowchart illustrating an example of the cleanliness registration process in the management method of the management system shown in FIG. 1.

FIG. 6 is a flowchart illustrating an example of the container retrieval process in the management method of the management system shown in FIG. 1.

FIG. 7 is a diagram showing the second embodiment of the management system of the present invention.

FIG. 8 is a diagram showing an example of the association between identification information, cleanliness, and location information stored in the database shown in FIG. 7.

FIG. 9 is a diagram showing an example of the internal configuration of the management device shown in FIG. 7.

FIG. 10 is a flowchart illustrating an example of the procedure of registering location information of containers in the management system shown in FIG. 7.

FIG. 11 is a diagram showing the third embodiment of the management system of the present invention.

FIG. 12 is a diagram showing an example of a container given the sensor shown in FIG. 11.

FIG. 13 is a diagram showing an example of the association between identification information, cleanliness, and usage information stored in the database shown in FIG. 11.

FIG. 14 is a diagram showing an example of the internal configuration of the management device shown in FIG. 11.

FIG. 15 is a flowchart illustrating an example of the procedure of registering container usage information in the management system shown in FIG. 11.

### DETAILED DESCRIPTION OF PREFERRED EMBODIMENTS

The following is a description of embodiments of the invention with reference to the drawings.

### First Embodiment

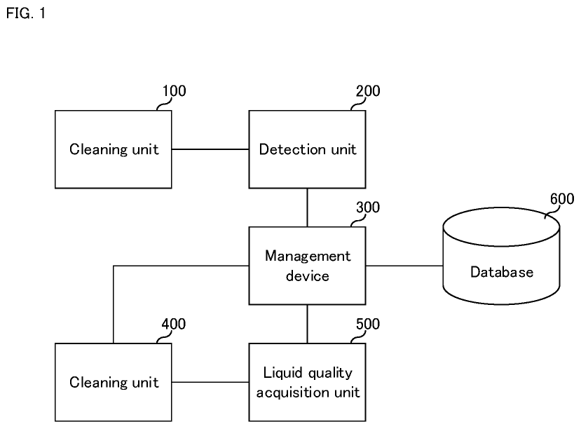

FIG. 1 is a diagram showing the first embodiment of the management system of the present invention. As shown in FIG. 1, the management system in this embodiment has cleaning units 100 and 400, detection unit 200, management device 300, liquid quality acquisition unit 500, and database 600. The object to be managed by the management system shown in FIG. 1 is a column or other container filled with (containing) fillers for processing liquids. The container is a cartridge with an inlet through which liquid flows in and an outlet through which the liquid flows out. Fillers for the containers are, for example, ion exchange resins, activated carbon, adsorbents, and zeolites such as molecular sieves. This configuration also applies in the following embodiments. Cleaning unit 400 and liquid quality acquisition unit 500 may not be included in the management system.

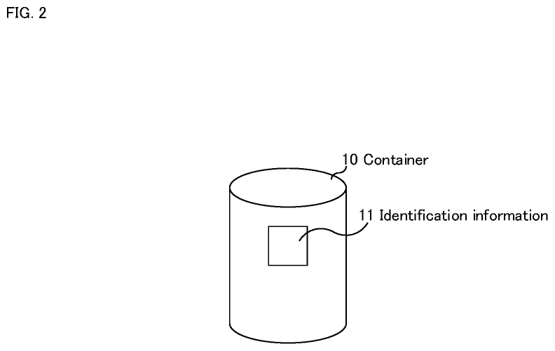

FIG. 2 is a diagram showing an example of a container managed by the management system shown in FIG. 1. As shown in FIG. 2, container 10 managed by the management system shown in FIG. 1 is assigned unique identification information 11 that can identify container 10. Identification information 11 may be indicated by a bar code or a two-dimensional code. In this case, the bar code or two-dimensional code showing identification information 11 is, for example, affixed, printed, or burned on container 10. A code reader is used to read identification information 11 indicated by a bar code or two-dimensional code. Identification information 11 may also be written electronically on an IC tag. In this case, an IC tag on which identification information 11 is electronically written is attached to container 10. An IC tag reader is used to read identification information 11 written on the IC tag. The code reader or IC tag reader transmits the read identification information 11 to management device 300.

Cleaning unit 100 is a second cleaning unit that cleans containers filled with filler. Cleaning unit 100 cleans the containers with filler in the containers. Cleaning unit 100 cleans the containers using organic solvents, pure water, or other liquids. The timing of cleaning the containers by cleaning unit 100 is after the return (collection) of used containers.

Detection unit 200 detects the state of contamination of the cleaning solution after cleaning unit 100 has cleaned the containers. Detection unit 200 acquires the properties of the cleaning solution (hereinafter referred to as liquid quality) after cleaning unit 100 has cleaned the containers, and detects the acquired results as the contamination status. Detection unit 200 transmits information indicating the detected contamination status to management device 300. The method of detecting contamination status is not limited. In the case of on-line measurement, the contamination status can be detected by, for example, measuring, pH, conductivity, specific resistance, TOC (Total Organic Carbon) concentration, and the number of particulates. A high measured conductivity, a low specific resistance, a high TOC concentration, or a high particle count is detected as a poor contamination level. In the case of off-line measurement, the contamination state can be detected by, for example, chromatography, atomic absorption, ICP-MS, or gel filtration measurements. This contamination status can be ascertained using information on the treatment solution used in the container and the contamination status of the filler and container. The contamination status can be a value indicated using units that show a given liquid quality, or can be an indicator of contamination level (e.g., classified from “1” to “5”). The contamination status indicates the level of contamination of the container and filler.

Cleaning unit 400 is a first cleaning unit that cleans containers from which the filler has been removed. Cleaning unit 400 washes the containers using a cleaning method determined by management device 300. The timing for cleaning containers by cleaning unit 400 is after cleaning unit 100 has cleaned the containers and the filler has been removed. Cleaning unit 100 and cleaning unit 400 may be realized as a single unit.

Liquid quality acquisition unit 500 acquires the liquid quality of the cleaning solution used for cleaning in cleaning unit 400. Liquid quality acquisition unit 500 may measure the liquid quality of the cleaning solution used for cleaning in cleaning unit 400 and acquire the measured value, or another measuring device may measure the liquid quality of the cleaning solution used for cleaning in cleaning unit 400 and liquid quality acquisition unit 500 may acquire the value measured by that measuring device. Liquid quality acquisition unit 500 transmits the acquired results to management device 300 as the cleanliness (first cleanliness). The measurement items and measurement methods of liquid quality are not limited. Measurement items may be conductivity, specific resistance, TOC concentration, particle count, and other items that can be measured online. The measurement method can be chromatography, atomic absorption, ICP-MS, or other methods for measuring ionic and elemental components.

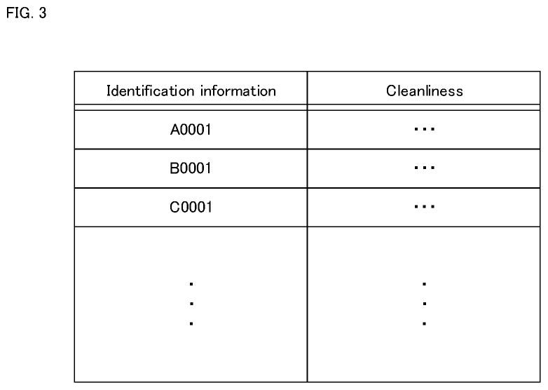

Database 600 stores the cleanliness indicating the liquid quality acquired by liquid quality acquisition unit 500 in association with the identification information assigned to the container. FIG. 3 is a diagram showing an example of the association between identification information and cleanliness stored in database 600 shown in FIG. 1. As shown in FIG. 3, database 600 stores the identification information assigned to each container and the respective associated cleanliness. The timing at which identification information is read from the container is not limited. The timing can be before cleaning unit 100 cleans the containers filled with filler, or after cleaning unit 400 cleans the containers from which the filler has been removed. The cleanliness can be a value indicated using units that indicate a given liquid quality, or it can be an indicator of cleanliness level (e.g., classified into five levels from “1” to “5”).

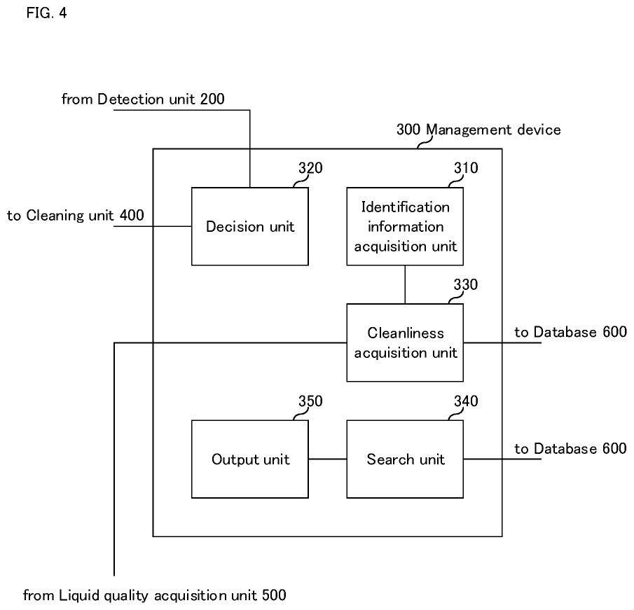

Management device 300 manages the containers that are to be managed. FIG. 4 is a diagram showing an example of the internal configuration of management device 300 shown in FIG. 1. As shown in FIG. 4, management device 300 shown in FIG. 1 has identification information acquisition unit 310, decision unit 320, cleanliness acquisition unit 330, search unit 340, and output unit 350. FIG. 4 shows only the major components of management device 300 shown in FIG. 1 that are relevant to this embodiment.

Identification information acquisition unit 310 acquires identification information from the container. Identification information acquisition unit 310 acquires identification information transmitted from code readers and IC tag readers. The preferred timing for identification information acquisition unit 310 to acquire the identification information is after the used container has been returned but before cleaning unit 100 cleans the container. Identification information acquisition unit 310 outputs the acquired identification information to cleanliness acquisition unit 330.

Decision unit 320 determines the cleaning method for a container from which the filler has been removed based on the contamination status detected by detection unit 200. Decision unit 320 may store in advance multiple cleaning methods for each of multiple contamination states and select the cleaning method corresponding to the contamination state detected by detection unit 200. If the contamination status detected by detection unit 200 is indicated by a numerical value, decision unit 320 may adopt a cleaning method calculated using that numerical value. Decision unit 320 notifies cleaning unit 400 of the determined cleaning method and instructs cleaning unit 400 to clean the containers using the cleaning method.

Cleanliness acquisition unit 330 acquires the cleanliness transmitted from liquid quality acquisition unit 500. Cleanliness acquisition unit 330 stores in the database the acquired cleanliness in association with the identification information acquired by identification information acquisition unit 310.

Search unit 340 searches database 600 for identification information associated with cleanliness that satisfies the conditions indicated by request information. Specifically, search unit 340 uses the conditions indicated by request information as search keys to search for cleanliness stored in database 600 that satisfies the conditions. In other words, search unit 340 determines cleanliness (second cleanliness) based on conditions indicated by request information, searches database 600 for a first cleanliness that corresponds to the second cleanliness, and retrieves the identification information associated with the first cleanliness that was retrieved in database 600. If the request information includes a value of the second cleanliness, search unit 340 searches database 600 for a first cleanliness corresponding to the value of the second cleanliness included in the request information. If first cleanliness that is the same value (or class, grade, range, etc. the following cases being the same value) as the second cleanliness that was determined by search unit 340 is stored in database 600, search unit 340 retrieves the identification information associated with the first cleanliness value from database 600. If first cleanliness that is the same value as the second cleanliness determined by search unit 340 is not stored in database 600, search unit 340 retrieves from database 600 identification information associated with a first cleanliness value that has a higher (greater) value than the determined second cleanliness value. At this time, search unit 340 may retrieve from database 600 identification information associated with a first cleanliness value that is closest to the second cleanliness value. This request information is information that is input from outside (e.g., input means operated by a user of the system). The request information is information indicating a request from a user who wishes to use a container and includes information indicating the range of cleanliness of the container that the user wishes to use. The request information includes, for example, information on the quality of the liquid acquired after passing through the filler (metal content concentration, TOC concentration, number of particles, turbidity, specific resistance, etc.) or information on the cleanliness of the container (metal content concentration, TOC concentration, number of particles, turbidity, specific resistance, etc.). The condition indicated by the request information may be a value indicated using a predetermined numerical unit or may be an index of cleanliness (e.g., classified from “1” to “5”). Search unit 340 outputs the retrieved identification information to output unit 350.

Output unit 350 outputs the identification information that was output from search unit 340. Output unit 350 may display the identification information on a predetermined screen or transmit the identification information to other devices. Output unit 350 may also output the identification information audibly or by printing it out.

Database 600 may store container information and usage history associated with the identification information. Container information and usage history include, for example, the date of manufacture of the container, the serial number and manufacturer of the container, the components of the container and its materials, the date, time, and place where the container was used, historical information of the filler used in the container (date, brand, lot number, warranty period, filling date, disposal date, etc.), the solvent that was passed through, delivery data (e.g., carrier, time taken for delivery, etc.), contamination status detected by detection unit 200 in the past, cleaning method used by cleaning unit 400 in the past, cleanliness acquired by liquid quality acquisition unit 500 in the past, date and time of cleaning by cleaning units 100 and 400 in the past, and inspection results if other inspections were conducted. Search unit 340 may also output this information in association with the retrieved identification information to output unit 350, and output unit 350 may also output the information. By storing this information in database 600 to manage containers, the use of each container can be monitored and prompt action can be taken if a problem arises regarding the container. In addition, the schedule of use for each container can be easily planned. In addition, various notices may be given to users of the containers, such as reminders regarding the use of such containers. For example, the usage status of containers can be ascertained based on information that is stored in database 600 about when the containers were shipped and whether they were returned. In the event of a problem such as failure to achieve the expected processing performance, information for investigating the cause can be acquired immediately by tracing the usage history and filler information stored in database 600. In addition, the use of containers can be predicted based on information stored in database 600 regarding the time period from shipment until return, and a schedule of use can be planned. Furthermore, if the usage status can be ascertained, users who have not returned containers for a certain period of time can be notified of the warranty expiration date of the filler, the need to return containers, and other important points to keep in mind.

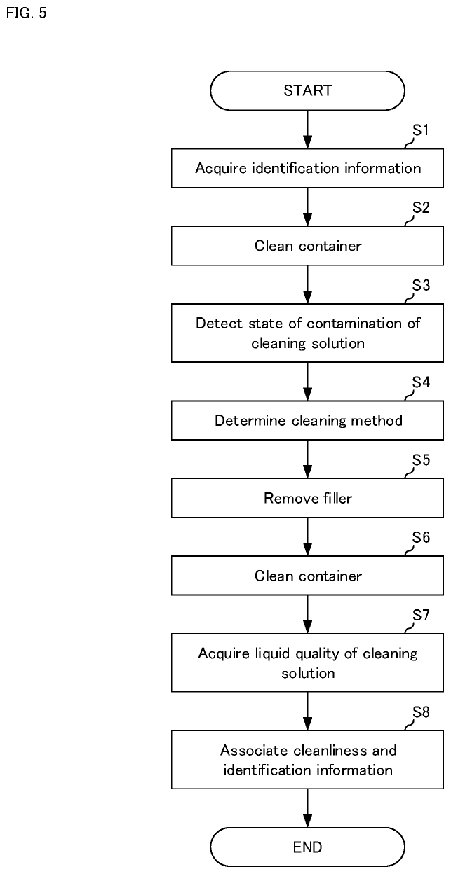

The following explanation describes the management method in the management system shown in FIG. 1. First, we will describe a cleanliness registration process among the management methods of the management system shown in FIG. 1. FIG. 5 is a flowchart illustrating an example of the cleanliness registration process in the management method of the management system shown in FIG. 1.

First, when a used container is returned, the identification information of the container that is read by a reader is acquired by identification information acquisition unit 310 (step S1). Cleaning unit 100 then uses cleaning solution to clean the container with the filler (step S2). Detection unit 200 detects the state of contamination of the cleaning solution after cleaning unit 100 has cleaned the container (step S3). Decision unit 320 determines the cleaning method for the container after the filler is removed based on the contamination status detected by detection unit 200 (step S4). The filler is then removed from the container (step S5), and cleaning unit 400 cleans the container from which the filler was removed using the cleaning method determined by decision unit 320 (step S6). Liquid quality acquisition unit 500 acquires a value indicating the liquid quality of the cleaning solution used by cleaning unit 400 (step S7). Cleanliness acquisition unit 330 stores in the database the cleanliness acquired by liquid quality acquisition unit 500 in association with the identification information acquired by identification information acquisition unit 310 (step S8). The containers are then dried and stored.

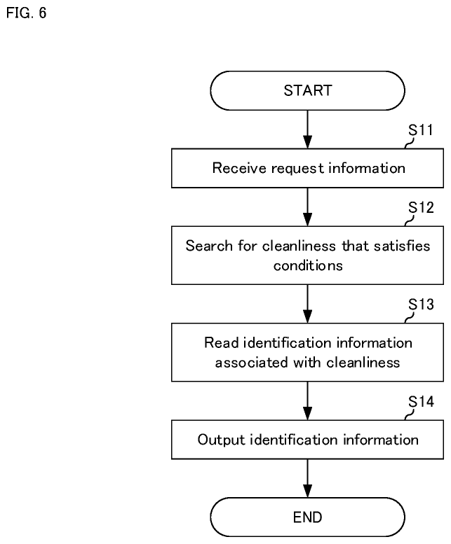

Next, we will explain a container retrieval process among the management methods of the management system shown in FIG. 1. FIG. 6 is a flowchart illustrating an example of the container retrieval process in the management method of the management system shown in FIG. 1.

First, management device 300 receives request information (step S11). Here, the method of receiving request information at management device 300 is not limited. For example, this process may be realized by a process in which management device 300 receives request information sent from a communication device that can communicate with management device 300, or it may be realized by a process in which request information is directly input to management device 300. Search unit 340 searches database 600 for cleanliness that meets the conditions indicated by the request information (step S12). Search unit 340 then reads the identification information associated with the retrieved cleanliness from database 600 (step S13). Output unit 350 then outputs the identification information read by search unit 340 (step S14). The container with the outputted identification information is then filled with filler based on the request information. Containers filled with filler are then cleaned and shipped.

In order for search unit 340 to search for identification information of a container that satisfies the conditions indicated by the request information in step S13, management device 300 performs the following procedure. First, management device 300 classifies containers after cleaning into multiple classes according to cleanliness. These multiple classes may be divided into, for example, “water (of lower quality than pure water or ultrapure water) grade,” “pure water grade,” “ultrapure water grade,” etc., or into multiple grades expressed using numerical values according to liquid quality, such as “grade 1” to “grade 5”. At this time, management device 300 compares the cleanliness with preset threshold values and classifies the containers into multiple classes based on the results of the comparison. When management device 300 receives request information, search unit 340 searches for a container of the class that satisfies the conditions indicated by the request information. At this time, if the received request information includes cleanliness, search unit 340 selects (retrieves) a container of a class that satisfies the cleanliness included in the request information. On the other hand, if the received request information does not include cleanliness, but includes conditions other than cleanliness, such as TOC concentration or number of particles, management device 300 first determines the cleanliness that satisfies the conditions included in the request information. This determination method can be a method in which management device 300 determines the cleanliness based on information that associates cleanliness with TOC concentration, number of particles, etc. in advance. This determination method can also use predetermined calculations to determine (calculate) cleanliness based on TOC concentration, number of particles, etc. Search unit 340 then selects a container of the class that satisfies the cleanliness requirements based on the determined cleanliness.

Thus, in this embodiment, the liquid quality of cleaning solution is measured after cleaning a container filled with filler that was used in a liquid treatment, and cleanliness that indicates the liquid quality that was measured is stored in the database in association with the identification information uniquely assigned to the container. When a user requests the use of a container, the system searches the database for identification information associated with cleanliness that satisfies the conditions of the request and outputs the information. Therefore, resources can be provided according to the needs of users. In addition, as long as the conditions indicated by request information are satisfied, it is possible to re-use (re-provide) other containers in addition to specific containers that are used by particular users. This allows for the sharing of containers and reduces costs and equipment.

### Second Embodiment

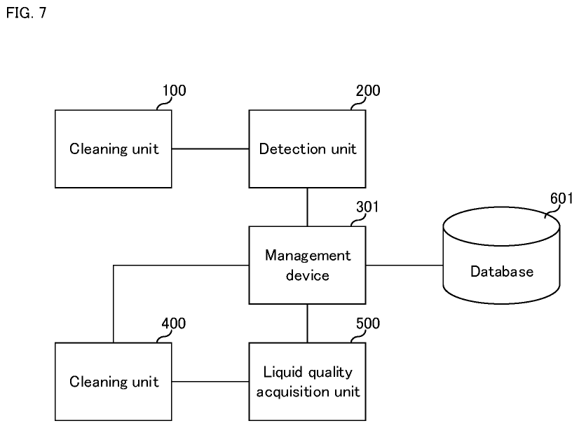

FIG. 7 is a diagram showing the second embodiment of the management system of the present invention. As shown in FIG. 7, the management system in this embodiment has cleaning units 100 and 400, detection unit 200, management device 301, liquid quality acquisition unit 500, and database 601. Each of cleaning units 100 and 400, detection unit 200, and liquid quality acquisition unit 500 is the same as its respective counterpart in the first embodiment.

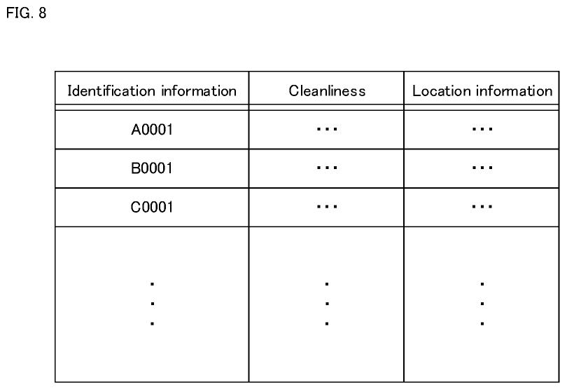

In addition to the information stored by database 600 in the first embodiment, database 601 stores location information indicating the location of containers. FIG. 8 is a diagram showing an example of the association between identification information, cleanliness, and location information stored in database 601 shown in FIG. 7. As shown in FIG. 8, database 601 stores the identification information assigned to each container, cleanliness, and location information. The identification information and cleanliness are each the same as in the first embodiment. Location information is information that indicates the location of the container and is acquired by any means. The location of the container is the location after the container has been shipped or before it is shipped (e.g., the location of the warehouse where the container is stored or the storage location in the warehouse).

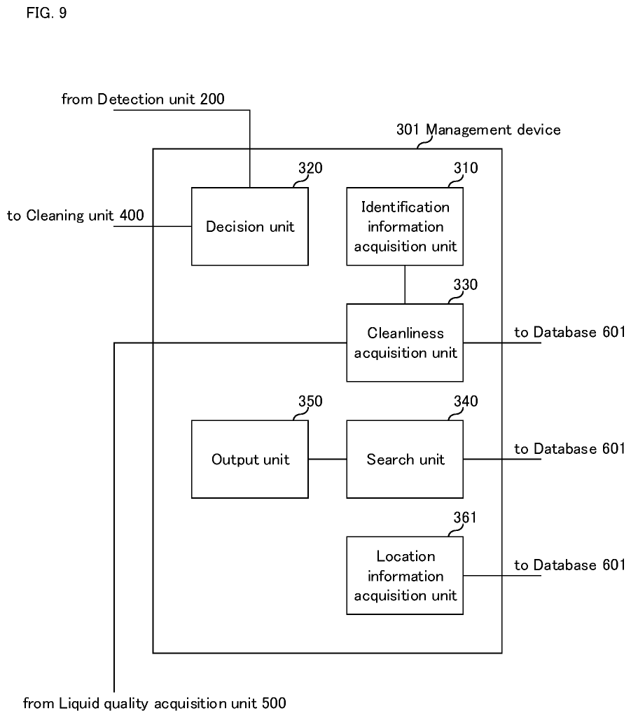

Management device 301 manages the containers to be managed. FIG. 9 is a diagram showing an example of the internal configuration of management device 301 shown in FIG. 7. As shown in FIG. 9, management device 301 shown in FIG. 7 has identification information acquisition unit 310, decision unit 320, cleanliness acquisition unit 330, search unit 340, output unit 350, and location information acquisition unit 361. FIG. 9 shows only the major components of management device 301 shown in FIG. 7 that are relevant to this embodiment. Identification information acquisition unit 310, decision unit 320, cleanliness acquisition unit 330, search unit 340, and output unit 350 are each the same as those in the first embodiment.

Location information acquisition unit 361 acquires location information indicating the location of a container. Location information acquisition unit 361 stores the acquired location information in database 601. At this time, location information acquisition unit 361 stores the location information in database 601 in association with the identification information of the container that is at the location indicated by the acquired location information. No particular limitations apply to the method by which location information is acquired by location information acquisition unit 361. For example, if the container is equipped with a GPS (Global Positioning System) function or other function for acquiring location information, the method may be one that uses this function to acquire the location. Alternatively, the method may also be one that calculates and acquires the location information based on the container delivery route and delivery time. When acquiring the location information of a container, location information acquisition unit 361 also acquires the identification information of the container along with the location information. The method of acquiring identification information is also not limited. The method of acquiring this information may be a method in which, for example, the identification information is transmitted from the container along with the location information. The method may also a method in which, when location information is calculated based on the delivery route and delivery time of a container, the identification information that is stored in database 601 in association with the delivery route and delivery time is acquired.

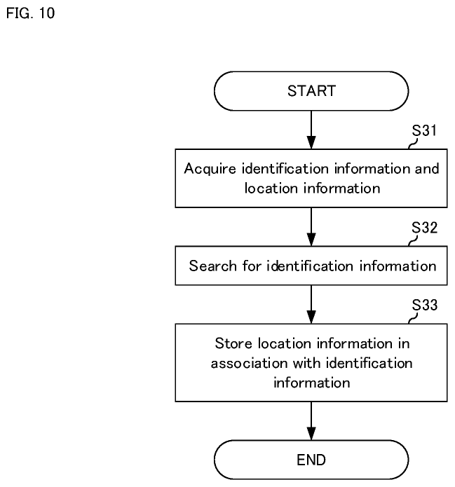

The following explanation describes how to register the location information of containers in the management system shown in FIG. 7. FIG. 10 is a flowchart illustrating an example of the registration of location information of containers in the management system shown in FIG. 7.

When location information acquisition unit 361 acquires the location information and identification information of a container (step S31), location information acquisition unit 361 retrieves the acquired identification information from database 601 (step S32). Location information acquisition unit 361 stores the location information in association with the identification information that it was able to retrieve in database 601 (step S33).

Thus, in this embodiment, location information indicating the location of containers is acquired and registered in a database in association with the identification information. This allows management of the current location of the containers. Knowing the current location of containers facilitates planning the use of the containers.

### Third Embodiment

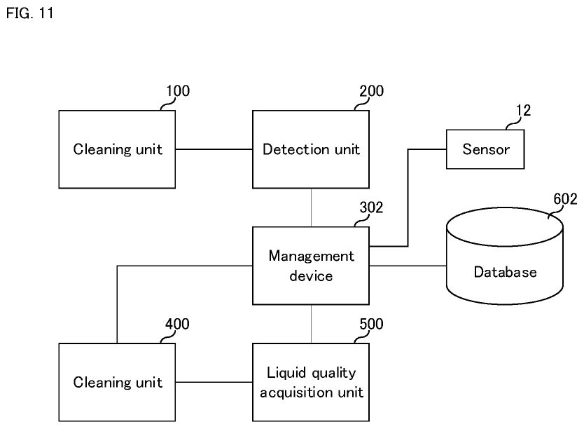

FIG. 11 is a diagram showing the third embodiment of the management system of the present invention. As shown in FIG. 11, the management system in this embodiment has cleaning units 100 and 400, detection unit 200, management device 302, liquid quality acquisition unit 500, database 602, and sensor 12. Each of cleaning units 100 and 400, detection unit 200, and liquid quality acquisition unit 500 is the same as its respective counterpart in the first embodiment.

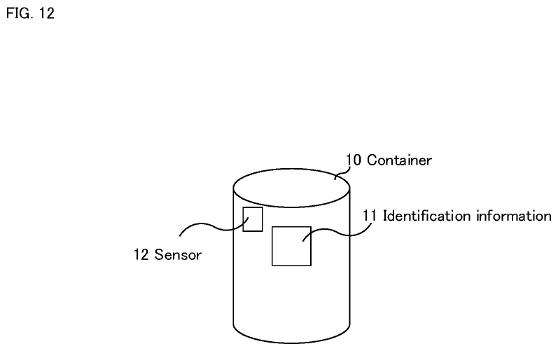

Sensor 12 is provided on a container and detects that the container has been used. FIG. 12 is a diagram showing an example of a container provided with sensor 12 shown in FIG. 11. As shown in FIG. 12, sensor 12 is attached to container 10 with identification information 11. Identification information 11 is the same as in the first embodiment. Sensor 12 detects that container 10 has been used. The mechanism by which sensor 12 detects that container 10 has been used is not limited. When sensor 12 detects that container 10 has been used, it sends identification information 11 assigned to container 10 to management device 302 included with a predetermined signal. This predetermined signal should be sufficient to allow recognition that container 10 to which sensor 12 is attached has been used.

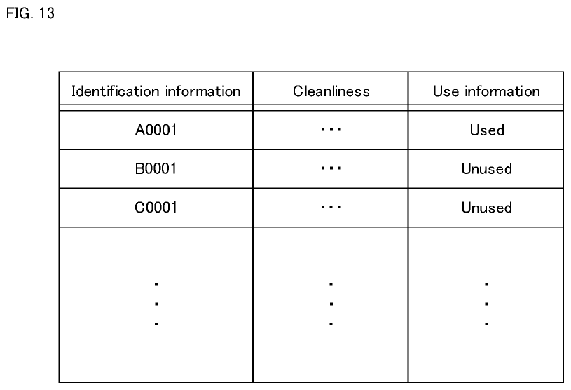

In addition to the information stored by database 600 in the first embodiment, database 602 stores usage information indicating whether the container has been used or not. FIG. 13 is a diagram showing an example of the association between identification information, cleanliness, and usage information stored in database 602 shown in FIG. 11. As shown in FIG. 13, database 602 stores cleanliness and usage information in association with the identification information assigned to each container. The identification information and cleanliness are the same as in the first embodiment. The usage information indicates whether the container has been used or not (used or still unused). The usage information is based on signals transmitted from sensor 12.

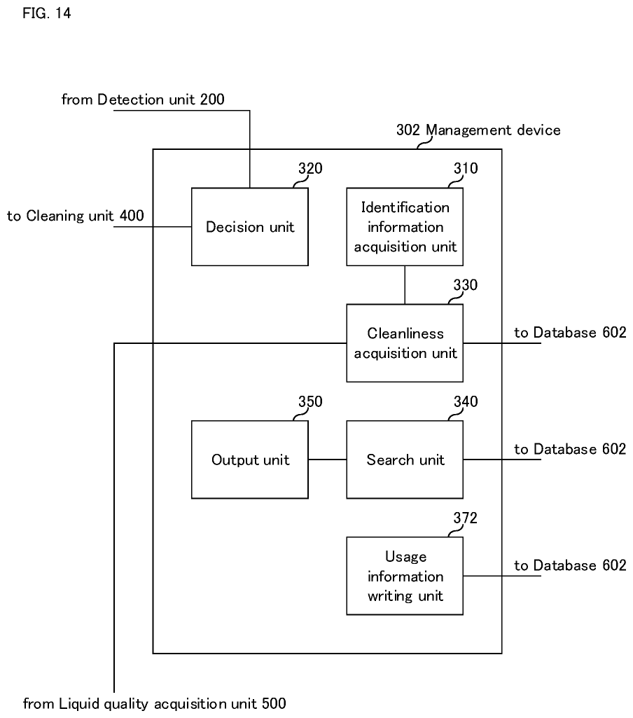

Management device 302 manages the containers that are to be managed. FIG. 14 is a diagram showing an example of the internal configuration of management device 302 shown in FIG. 11. As shown in FIG. 14, management device 302 shown in FIG. 11 has identification information acquisition unit 310, decision unit 320, cleanliness acquisition unit 330, search unit 340, output unit 350, and usage information writing unit 372. FIG. 14 shows only the major components of management device 302 shown in FIG. 11 that are relevant to this embodiment. Identification information acquisition unit 310, decision unit 320, cleanliness acquisition unit 330, search unit 340, and output unit 350 are each the same as the corresponding elements in the first embodiment.

Usage information writing unit 372 stores in database 602 the usage information of a container based on the information indicated by the signal transmitted from sensor 12. Usage information writing unit 372 causes storage of the information “unused” as the usage information associated with the identification information assigned to the container when the container is shipped, and rewrites the usage information to “used” when a prescribed signal is sent from sensor 12. Sensor 12 may also have the ability to determine the time of use (operation time).

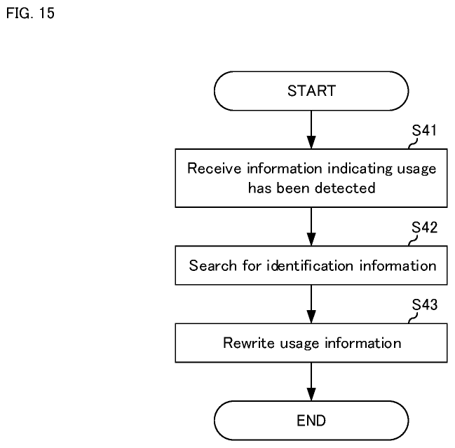

The following explanation describes the method of registering container usage information in the management system shown in FIG. 11. FIG. 15 is a flowchart illustrating an example of the process of registering container usage information in the management system shown in FIG. 11.

When sensor 12 sends a predetermined signal indicating that it has detected that the container has been used and usage information writing unit 372 receives the signal (step S41), usage information writing unit 372 retrieves the identification information contained in the signal from database 602 (step S42). Usage information writing section 372 rewrites the usage information associated with the retrieves identification information from “unused” to “used” (step S43).

Thus, in this embodiment, when a signal is received from a sensor attached to a container indicating that the sensor has detected the use of the container, the usage information that is stored in the database in association with the identification information contained in the signal is rewritten to indicate that the container has been used. This allows the current state of use of the container to be managed. The ability to recognize the state of use also allows the system to notify a user holding a container that the warranty expiration date of unused filler in the container is approaching. Further, based on information such as the usage status and duration of use acquired from sensor 12 and the history of orders, shipments, and returns stored in database 600, the rotating cycle of containers can be automatically calculated to create a shipping schedule for the containers.

Although the present invention has been described above by allocating each function (process) to a component, these assignments are not limited to those described above. In addition, as for the configuration of the components, the above-described embodiments are merely examples and the present invention is not limited thereto. Further, the present invention may be a combination of the embodiments. Management devices 300 to 302 and databases 600 to 602 may be connected to other components via a communication network or located in the cloud.

The processing performed by each of management devices 300 to 302 may be performed by logic circuits manufactured according to the purpose. Further, a computer program (hereinafter, referred to as a “program”) in which the processing contents are described as procedures may be recorded on a recording medium that can be read by management devices 300 to 302, and the programs recorded on the recording medium may be read into and executed by management devices 300 to 302. The recording medium that can be read by management devices 300 to 302 may refer to memory such as ROM (Read Only Memory) or RAM (Random Access Memory), or to an HDD (Hard Disc Drive), SSD (Solid State Drive), or the like that is incorporated in management devices 300 to 302, or may further refer to a transferable recording medium such as a floppy (registered trademark) disk, a magneto-optical disk, a DVD (Digital Versatile Disc), a CD (Compact Disc), a Blu-ray (registered trademark) Disc, or a USB (Universal Serial Bus) memory. The program recorded on the recording medium is read by a CPU provided in each of management devices 300 to 302, and the same processing as that described above is performed under the control of the CPU. Here, the CPU operates as a computer that executes a program read from a recording medium on which the program is recorded.

1. A management system, comprising:
a database that stores a first cleanliness indicating liquid quality of cleaning solution after a first cleaning unit that cleans containers to which unique identification information is assigned has cleaned the container in association with the identification information assigned to the container;
a search unit that searches the database for identification information associated with the first cleanliness that corresponds with a second cleanliness requested from the outside; and
an output unit that outputs the identification information that was retrieved by the search unit.

2. The management system according to claim 1, wherein
the management system determines the second cleanliness based on conditions that are received; and
the search unit searches the database for identification information associated with the first cleanliness according to the determined second cleanliness.

3. The management system according to claim 1, further comprising:
a second cleaning unit that cleans the container with filler in the container;
a detection unit that detects the state of contamination of cleaning solution after the second cleaning unit has cleaned the container; and
a decision unit that determines a cleaning method for the container from which the filler was removed based on the contamination status detected by the detection unit; wherein
the first cleaning unit cleans the container from which the filler was removed using the cleaning method determined by the decision unit.

4. The management system according to claim 1, wherein the database stores usage history of the containers in association with the identification information assigned to the containers.

5. The management system according to claim 1, further comprising:
a location information acquisition unit that acquires location information indicating the location of the containers, wherein
the database stores the location information of the container acquired by the location information acquisition unit in association with the identification information assigned to the container.

6. The management system according to claim 1, further comprising:
a sensor that detects whether the container has been used, wherein
the database stores the results of the detection by the sensor in association with the identification information assigned to the container.

7. The management system according to claim 1, wherein the container is a cartridge with an inlet through which liquid flows and an outlet through which liquid that has flowed in flows out.

8. A management device, comprising:
an identification information acquisition unit that acquires identification information uniquely assigned to a container;
a decision unit that determines a cleaning method for the container from which filler has been removed based on the state of contamination of cleaning solution after the container was cleaned with the filler in it;
a cleanliness acquisition unit that acquires a first cleanliness indicating liquid quality of cleaning solution after cleaning the container from which the filler has been removed using the cleaning method determined by the decision unit, and stores in a database the acquired first cleanliness in association with the identification information that was assigned to the container and that was acquired by the identification information acquisition unit;
a search unit that searches the database for identification information associated with the first cleanliness that corresponds with a second cleanliness requested from the outside; and
an output unit that outputs the identification information retrieved by the search unit.

9. A management method, comprising:
acquiring identification information uniquely assigned to a container;
cleaning the container;
acquiring liquid quality of cleaning solution after cleaning the container;
storing in a database a first cleanliness indicating the acquired liquid quality in association with the acquired identification information assigned to the container;
searching the database for identification information associated with the first cleanliness that corresponds with a second cleanliness requested from the outside; and
outputting the identification information that was retrieved.

10. A computer readable medium including a program to make a computer execute procedures, the procedures comprising:
a procedure for acquiring identification information uniquely assigned to a container;
a procedure for cleaning the container;
a procedure for acquiring liquid quality of cleaning solution after cleaning the container;
a procedure of storing in a database a first cleanliness indicating the acquired liquid quality in association with the acquired identification information assigned to the container;
a procedure for searching the database for identification information associated with the first cleanliness that corresponds with a second cleanliness requested from the outside; and
a procedure for outputting the identification information that was retrieved.

11. The management system according to claim 2, further comprising:
a second cleaning unit that cleans the container with filler in the container;
a detection unit that detects the state of contamination of cleaning solution after the second cleaning unit has cleaned the container; and
a decision unit that determines a cleaning method for the container from which the filler was removed based on the contamination status detected by the detection unit; wherein
the first cleaning unit cleans the container from which the filler was removed using the cleaning method determined by the decision unit.

12. The management system according to claim 2, wherein the database stores usage history of the containers in association with the identification information assigned to the containers.

13. The management system according to claim 2, further comprising:
a location information acquisition unit that acquires location information indicating the location of the containers, wherein
the database stores the location information of the container acquired by the location information acquisition unit in association with the identification information assigned to the container.

14. The management system according to claim 2, further comprising:
a sensor that detects whether the container has been used, wherein
the database stores the results of the detection by the sensor in association with the identification information assigned to the container.

15. The management system according to claim 2, wherein the container is a cartridge with an inlet through which liquid flows and an outlet through which liquid that has flowed in flows out.
